(19) United States
(12) Patent Application Publication
(10) Pub. No.: US 2010/0009713 A1
(43) Pub. Date: Jan. 14, 2010

(54) LOGO RECOGNITION FOR MOBILE AUGMENTED REALITY ENVIRONMENT

(76) Inventor: Carl Johan Freer, Westport, CT (US)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/172,857

(22) Filed: Jul. 14, 2008

(51) Int. Cl. G06K 9/62; H04M 1/02

(52) U.S. Cl. 455/556.1; 382/181; 382/170

(57) ABSTRACT

An augmented reality platform is provided which interacts between a mobile device and a server via a communication network. The augmented reality platform includes an image processing application located on the mobile device which receives a live, real-time image and converts the image into coordinates, and a client application located on the mobile device which transmits a data packet including the coordinates. A server application provided on the server receives the data packet from the client application, recognizes a logo included in the live, real-time image by identifying the log ID and measuring the useful characterization information such as position, size and orientation, and sends content or a link thereto to the mobile device in accordance with the logo. The client application on the mobile device processes the content or the link thereto and forms an augmented reality image on a display of the mobile device based on the recognized result of the logo and the delivered real-world image contents.

### FIELD OF THE INVENTION

The present invention relates to a method of logo recognition for implementing augmented reality applications on mobile communication systems.

The present invention also relates to the implementation of a software platform that performs logo detection and identification over a client-server structure in a mobile augmented reality environment.

The present invention also relates to schemes for implementing the software platform to integrate the logo recognition results and augmented reality applications, and to retrieve and deliver appropriate augmented reality content to mobile devices.

### BACKGROUND OF THE INVENTION

Logos are generally considered symbols associated with particular goods and/or services and may be trademarks of the entity providing the goods and/or services. Nowadays people are never in closer proximity to logos and more associate the logo with the particular goods and/or services; at the same time people are also in their closest access to the advanced mobile communication devices, such as personal digital assistant (PDA) and cellular telephones (e.g., cellular camera phones). Such electronic devices typically include a camera or other imaging component capable of obtaining images to be displayed on a display component. An intuitive but of great potential application is the combination of imaging and recognition of logos with novel mobile services such as retrieval and display of augmented reality enhanced data in the mobile devices.

However, current mobile devices are neither capable of recognizing a logo in an image obtained by the device, nor capable of responding to the recognition of a logo, leaving the logo-recognition based mobile augmented realty application yet-achieved.

### SUMMARY OF THE INVENTION

The present invention provides a new method for implementing logo recognition that is associated with mobile augmented reality environments.

According to one aspect of the present invention, the recognition method consists of the development of logo pattern recognition algorithm. The algorithm is capable of generating following information of the recognized logo:
Identification of the logo: The input logo that is presented in the captured image is recognized by matching a set of extracted features in the image to the database of known logos using a Support Vector Machine (SVM) classifier, that is invariant to occlusion, rotation, scale and illumination of the images
Position and orientation of the logo
Dimension of the logo in the image

According to another aspect of the present invention, a software platform is provided which implements the logo recognition algorithm in a client-server architecture, which enables live image capture (at the mobile device) and image processing and logo recognition in the server. The software platform establishes connections between the mobile device and other servers and network components via one or more communications networks transmitting communications or signals between the mobile device and the server and network components, retrieving data from databases resident on the mobile device or at the server or from other databases remote from the mobile device, cataloging data about content to be provided to the mobile device for the augmented reality experience and establishing and maintaining a library of content for use in augmenting reality using the mobile device. With such a structure, the invention provides a complete mobile delivery platform and can be created to function on all active mobile device formats (regardless of operating system).

More specifically, an augmented reality platform in accordance with the invention provides for real-time live pattern recognition of logos using mobile devices involving one or more remote network components. Ideally, the live, real-time image obtained by the imaging component of the mobile device would constitute only the logo. When a logo in an obtained image has been recognized, or identified, the mobile device sends a signal derived from the logo to a main server. The main server determines appropriate content to provide to the mobile device based on the signal derived from the logo, i.e., based on the logo.

An advantage of the involvement of a main server remotely situated to the mobile devices, and which facilitates the pattern matching and content retrieval, is that it easily allows for the introduction of new logos to a library or database of logos on an ongoing basis so that the programming on the mobile devices does not require updates whenever a new logo is created and it is sought to provide content to mobile devices which obtain images including this new logo.

Another advantage is that the computing power necessary to perform pattern matching may be provided by the main server which has virtually no limitations on size, whereas performing pattern matching on the mobile device is limited in speed in view of the size of the mobile device's hardware components.

### BRIEF DESCRIPTION OF THE DRAWINGS

The invention, together with further advantages thereof, may best be understood by reference to the following description taken in conjunction with the accompanying drawings, wherein like reference numerals identify like elements, and wherein:

FIG. 1 is a schematic diagram showing the primary components of an augmented reality platform in accordance with the invention.

FIG. 2 is a schematic diagram showing the logo recognition algorithm

### DETAILED DESCRIPTION OF THE INVENTION

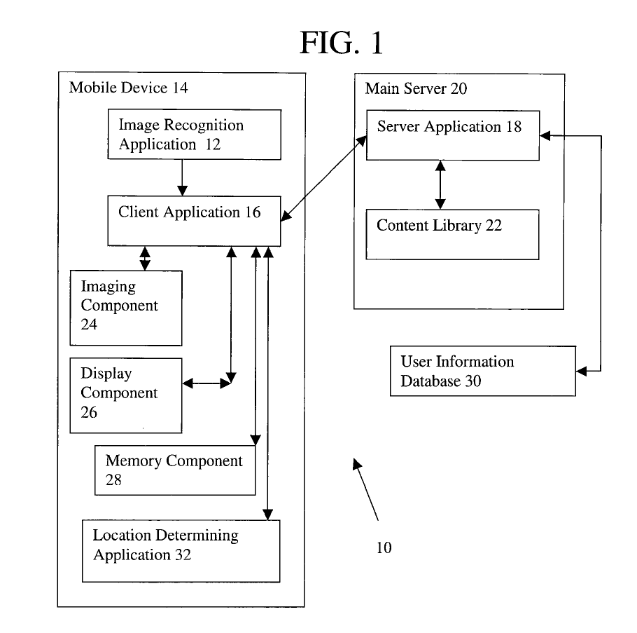

Referring to the accompanying drawings wherein like reference numerals refer to the same or similar elements, FIG. 1 shows primary components of the augmented reality platform which interacts with logos in accordance with the invention, designated generally as 10. The primary components of the platform 10 include an image recognition application 12 located on the user's mobile device 14, a client application 16 located and running on the user's mobile device 14, a server application 18 located and running on a (main) server 20, and a content library 22 which contains the content or links thereto being provided to the mobile device 14. All of the primary components of the platform 10 interact with one another, e.g., via a communications network, such as the Internet, when the interacting components are not co-located, i.e., one component is situated on the mobile device 14 and another is at a site remote from the mobile device 14 such as at the main server 20.

The image recognition application 12 is coupled to the imaging component 24 of the mobile device 14, i.e., its camera, and generally comprises software embodied on computer-readable media which analyzes images being imaged by the imaging component 24 (which may be an image of only a logo or an image containing a logo) and interprets this image into coordinates which are sent to the client application 16. The images are not necessarily stored by the mobile device 14, but rather, the images are displayed live, in real-time on the display component 26 of the mobile device 14.

To aid in the interpretation of the images into coordinates, a marker may be formed in combination with the logo and is related to, indicative of or provides information about the logo. As such, the coordinates may be generated by analyzing the marker. The marker may be a frame marker forming a frame around the logo.

The client application 16 may be considered the central hub of software on the mobile device 14. It receives the coordinates from the image recognition application 12 and transmits that information (e.g. via XML) to the server application 18. After the server application 18 locates the appropriate content or a link thereto, based on the coordinates, and sends the content to the mobile device 14, the client application 16 processes that content or link thereto and forms a display on the display component 26 of the mobile device 14 based on the live image and the content.

The server application 18 may be located on a set of servers interconnected by the Internet. The client application 16 contacts the server application 18 and passes a query string, containing the coordinates derived from the live, real-time image being imaged by the mobile device 14. The server application 18 parses that string, identifies the live image as a legitimate image (for which content or a link thereto could be provided), queries the content library 22, retrieves the proper content or link thereto from the content library 22 and then encrypts the content or link thereto and directs it to the client application 16.

Additionally, the server application 18 may be designed to log the activity, track and create activity reports and maintain communication with all active client applications 16. That is, the server application 18 can handle query strings from multiple client applications 16.

The content library 22 may be located on a separate set of servers than the server application 18, or possibly on the same server or set of servers. The illustrated embodiment shows the main server 20 including both the server application 18 and the content library 22 but this arrangement is not limiting and indeed, it is envisioned that the content library 22 may be distributed over several servers or other network components different than the main server 20.

The content library 22 stores all augmented reality content and links thereto that are to be delivered to client applications 16. The content library 22 receives signals from the server application 18 in the form of a request for content responsive to coordinates derived by the image recognition application 12 from analysis of a live, real-time image. When it receives the request, the content library 22 first authenticates the request as a valid request, verifies that the server application 18 requesting the information is entitled to receive a response, then retrieves the appropriate content or link thereto and delivers that content to the server application 18.

To use the platform 10, the user's mobile device 14 would be provided with the client application 16 which may be pre-installed on the mobile device 14, i.e., prior to delivery to the user, or the user could download the client application 16 via an SMS message, or comparable protocol for delivery, sent from the server application 16.

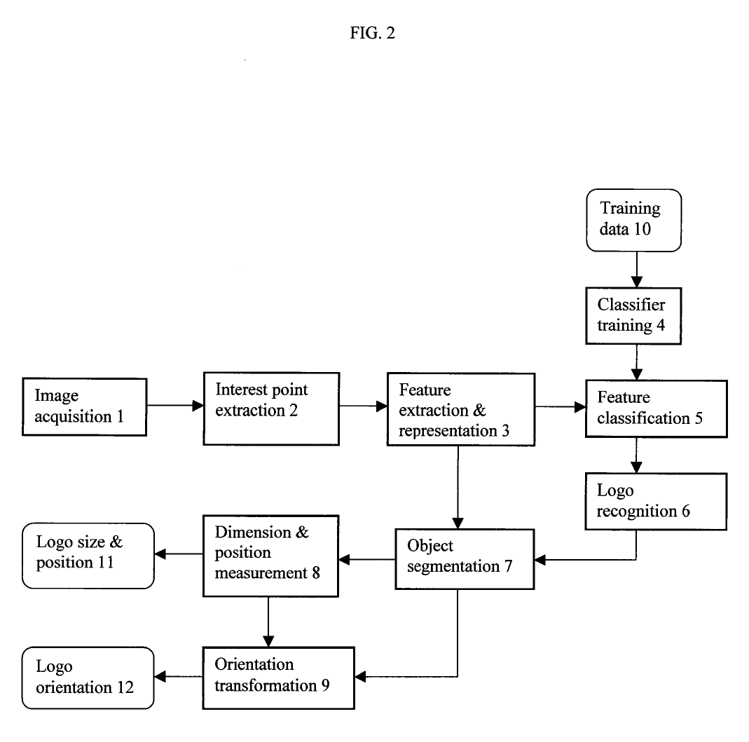

The logo recognition algorithm is illustrated in FIG. 2 wherein the reference numerals refer to the same in the following descriptions. The input image that contains a logo is acquired using a mobile device with a camera as 1. Depending on the processing platform of the mobile device, the image either remains in the mobile device or is transmitted to the server for processing to extract points of interest in the image by a point detector 2. The point detector is implemented using FAST corner detector.

For each of the extracted interest points, extract the feature descriptor of the interest point 3. The feature descriptor is the normalized intensity pixel patch centered at the point. For each of the input image a set of the features of all the interest points is represented as the input feature to be classified by the feature classifier 5.

A set of images of the known logos are processed so that the point feature descriptors are extracted as in 3. These data are used as training data 10 to train a SVM classifier that is based on Pyramid Match Kernel 5.

The identification of the logo in the input is achieved 6 by recognizing the classification results obtained in 5.

The features of the recognized logo are back-projected in the input image so that the logo is segmented from the background in the image 7. The dimensional measurement is performed on the segmented logo points so that the rough image size of the logo can be determined 8. The position of the logo is defined as the centroid of the cluster of the feature points of the logo 11.

The extracted feature pattern of the logo is compared to a set of oriented patterns of the recognized log data 9 so that the orientation of the logo can be determined 12.

While the invention has been described above with respect to specific apparatus and specific implementations, it should be clear that various modifications and alterations can be made, and various features of one embodiment can be included in other embodiments, within the scope of the present invention.

1. A distributed augmented reality platform which interacts between a mobile device and a server, comprising:
an image recognition application located on the mobile device which receives a live, real-time image imaged by an imaging component of the mobile device, and which converts the image into coordinates;
a client application located on the mobile device which receives the coordinates from the image recognition application, and which transmits a data packet or packets including the coordinates;
a server application located on the server which receives the transmission of the data packet from the client application, performs the recognition of the logo in the input image from the client, determines content to be provided to the mobile device based on the coordinates, and sends the content or a link thereto to the mobile device.

2. A interest point detector algorithm as a component part of the logo recognition algorithm used in claim 1 is implemented as a corner detector program.

3. A SVM based classifier that is based on the multi-resolution histogram intersection matching method is implemented to performed the pattern classification using sets of the extracted feature points obtained in claim 2, as a component of the logo recognition algorithm of claim 1.

4. A segmentation algorithm that is based on the comparison of the recognized features obtained in claim 3 is implemented. Based on the segmented object information, the dimensional, positional and orientation information of the logo is calculated.

5. The distributed augmented reality platform of claim 1, further comprising a content library which is coupled to the server application and which stores content and/or links associated with logos and wherein the client application on the mobile device is adapted to process the content or the link thereto and to form an augmented reality image on a display of the mobile device based on the live, real-time image and the content.

6. The distributed augmented reality platform of claim 5, wherein the server application is adapted to recognize a logo included in the image imaged by the imaging component of the mobile device based on the coordinates included in the data packet received from the client application, and wherein the server application retrieves the content or the link thereto to be provided to the mobile device from the content library based on the recognized logo.

7. The distributed augmented reality platform of claim 1, wherein the augmented reality image comprises the content superimposed on the live, real-time image.

8. The distributed augmented reality platform of claim 1, further comprising a memory which stores information about a user of the mobile device, wherein the server application obtains the information about the user from the memory and determines the content or the link thereto to be provided to the mobile device based on the information about the user as well as the coordinates included in the data packet received from the client application.

9. The distributed augmented reality platform of claim 1, further comprising a location determining application which determines a location of the mobile device, wherein the server application obtains the location of the mobile device from the location determining application and determines the content or the link thereto to be provided to the mobile device based on the obtained location as well as the coordinates included in the data packet received from the client application.

10. A method of providing an augmented reality experience on a mobile device, comprising:
obtaining a live, real-time image using an imaging component of the mobile device;
identifying a logo contained in the image;
providing the mobile device with content or a link thereto based on the identified logo.

11. The method of claim 10, wherein the mobile device derives coordinates of the live, real-time image and transmits the derived coordinates to a server in a data packet, and wherein the server identifies the logo contained in the image based on the coordinates included in the data packet.

12. The method of claim 8, wherein the server is coupled to a content library which stores content and/or links associated with logos, and the server retrieves the content or the link thereto to be provided to the mobile device from the content library based on the identified logo.

13. The method of claim 10, wherein the mobile device displays an augmented reality image comprising the content superimposed on the live, real-time image.

14. The method of claim 11, further comprising storing information about a user of the mobile device, and determining the content or the link thereto to be provided to the mobile device based on the information about the user as well as the coordinates included in the data packet.

15. The method of claim 8, further comprising determining a location of the mobile device, and determining the content or the link thereto to be provided to the mobile device based on the determined location as well as the coordinates included in the data packet.

16. The method of claim 10, wherein the logo contained in the live, real-time image is identified by identifying a marker formed in combination with the logo.

17. The method of claim 16, wherein the marker comprises a frame formed around the logo.

18. The method of claim 14, wherein the content comprises an advertisement for goods or services associated with the logo.

19. A mobile device comprising:
an imaging component which obtains a live, real-time image, and converts the image into coordinates;
a transmitting unit which transmits a data packet including the coordinates;
a receiving unit which receives content or a link thereto which is determined based on the coordinates and potentially other data; and
a display which displays an image based on the content.

20. The mobile device of claim 19, wherein the image displayed by the display comprises an augmented reality image in which the content is superimposed on the live, real-time image obtained by the imaging component.

21. The mobile device of claim 19, further comprising a memory storing information about a user of the mobile device, wherein the content or the link thereto received by the receiving unit is determined based on the information about the user as well as the coordinates included in the data packet.

22. The mobile device of claim 19, further comprising a location determining device which determines a location of the mobile device, wherein the content or the link thereto received by the receiving unit is determined based on the obtained location as well as the coordinates included in the data packet.

23. The mobile device of claim 19, wherein the coordinates of the data packet include the coordinates of a logo.
